(19) United States
(12) Patent Application Publication
(10) Pub. No.: US 2024/0420075 A1
(43) Pub. Date: Dec. 19, 2024

(54) DELIVERY ASSISTANCE DEVICE

(71) Applicant: TOYOTA JIDOSHA KABUSHIKI KAISHA, Aichi-ken (JP)

(72) Inventors: Yohei NAKANISHI, Nagoya-shi (JP); Toshiharu FUKUMURA, Nagakute-shi (JP); Adrian NICOL, Nagoya-shi (JP); Ryuichi DANNO, Kasugai-shi (JP); Toshinori KIMURA, Ichinomiya-shi (JP); Yoshiaki ABE, Kofu-shi (JP)

(21) Appl. No.: 18/739,324

(22) Filed: Jun. 11, 2024

(30) Foreign Application Priority Data
Jun. 16, 2023 (JP) 2023-099305

(51) Int. Cl. G06Q 10/0835

(52) U.S. Cl. CPC G06Q 10/08355

(57) ABSTRACT

A delivery assistance device includes a first database in which daily schedules of customers are registered, and a second database in which a delivery schedule of parcels in a delivery vehicle is registered. A controller of the delivery assistance device sets a delivery location and a delivery date and time based on daily schedules of customers and a delivery schedule of parcels in a delivery vehicle. The controller proposes the delivery location and the delivery date and time to the corresponding customer.

### CROSS-REFERENCE TO RELATED APPLICATIONS

This application is based upon and claims the benefit of priority from prior Japanese Patent Application No. 2023-099305, filed on Jun. 16, 2023, the entire contents of which are incorporated herein by reference.

### BACKGROUND

### 1. Field

The present disclosure relates to a delivery assistance device.

### 2. Description of Related Art

Japanese Laid-Open Patent Publication No. 2003-292162 discloses a delivery notification system that informs a customer who receives a delivery service of the preferred redelivery date and time for a specified parcel based on the schedule of the customer.

In the case of a customer who frequently leaves home, even when the delivery person goes to the customer's home on the date and time designated by the system, the customer may be absent again.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a delivery assistance device is configured to assist delivery of parcels to customers who receive a parcel delivery service using a delivery vehicle. The delivery assistance device includes a first database in which daily schedules of the customers are registered, a second database in which a delivery schedule of the parcels in the delivery vehicle is registered, and a controller that includes processing circuitry. The processing circuitry is configured to set a delivery location and a delivery date and time at which the delivery vehicle delivers each parcel to the corresponding customer based on the daily schedules of the customers and the delivery schedule of the parcels in the delivery vehicle. The processing circuitry is also configured to propose the delivery location and the delivery date and time to the corresponding customer.

Other features and aspects will be apparent from the following detailed description, the drawings, and the claims.

### BRIEF DESCRIPTION OF THE DRAWINGS

FIG. 1 is a configuration diagram illustrating a delivery assistance device and an information terminal owned by a customer who receives a delivery service according to an embodiment.

FIG. 2 is a diagram illustrating an example of information registered in a first database included in the delivery assistance device of FIG. 1.

FIG. 3 is a diagram illustrating an example of information registered in a second database included in the delivery assistance device of FIG. 1.

FIG. 4 is a diagram illustrating an example of information registered in a third database included in the delivery assistance device of FIG. 1.

FIG. 5 is a sequence diagram illustrating a flow of processes when proposing a delivery location and a delivery date and time of a parcel to a customer.

FIG. 6 is a flowchart showing a series of processes executed by a controller included in the delivery assistance device of FIG. 1.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

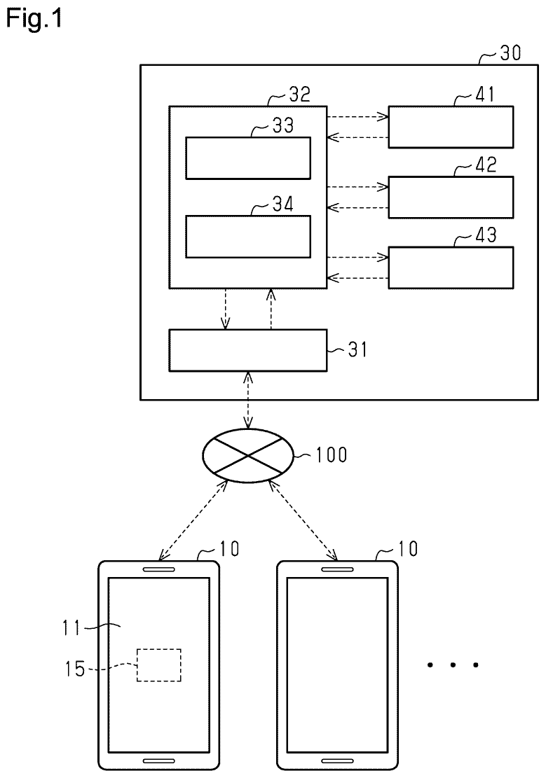

Hereinafter, an embodiment of a delivery assistance device will be described with reference to FIGS. 1 to 6.

FIG. 1 shows a delivery assistance device 30 and multiple information terminals 10. The information terminal 10 is an electronic device owned by a customer who receives a parcel delivery service using a delivery vehicle. The information terminal 10 can transmit and receive various kinds of information to and from the delivery assistance device 30 via the communication network 100. Examples of the information terminal 10 include a smartphone, a tablet terminal, and a personal computer.

### Information Terminal

The information terminal 10 includes a user interface 11 and processing circuitry 15. The user interface 11 includes a display screen and an operation unit. An example of the processing circuitry 15 is an electronic control unit. When the operation unit is operated by the user, the processing circuitry 15 executes processing corresponding to the operation. Then, the processing circuitry 15 transmits information indicating an execution result of the process to the delivery assistance device 30 via the communication network 100. Further, when the information terminal 10 receives information from the delivery assistance device 30 via the communication network 100, the processing circuitry 15 displays the received information on the display screen of the user interface 11.

### Delivery Assistance Device

The delivery assistance device 30 includes a communication device 31, a controller 32, a first database 41, a second database 42, and a third database 43.

The communication device 31 is an interface of the delivery assistance device 30 for transmitting and receiving information to and from an external communication device via the communication network 100. The communication device 31 outputs information received via the communication network 100 to the controller 32. The communication device 31 transmits information output by the controller 32 to the information terminal 10 via the communication network 100.

An example of the controller 32 is an electronic control unit. In this case, the controller 32 has a CPU 33 and a memory 34. The memory 34 stores a control program executed by the CPU 33. When the CPU 33 executes the control program of the memory 34, the controller 32 sets a delivery location and a delivery date and time at which the parcel is delivered to the customer by the delivery vehicle. Then, the controller 32 proposes the set delivery location and delivery date and time to the customer. Specific contents of such a series of processes will be described later.

### First Database

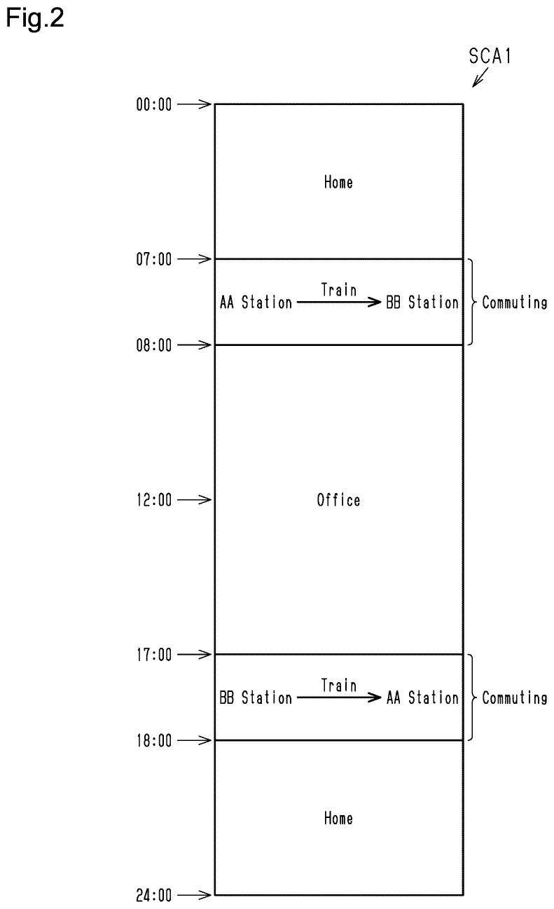

The information registered in the first database 41 will be described with reference to FIG. 2. In the first database 41, daily schedules SCA of multiple customers are registered. Hereinafter, the daily schedule SCA of the customer is referred to as a daily schedule SCA.

FIG. 2 illustrates a daily schedule SCA1 of a certain day of a first customer among multiple customers. In the example shown in FIG. 2, the daily schedule SCA1 is as follows.

The first customer is at home, for example, until about 07:00.

The first customer leaves home, for example, at about 07:00 and arrives at the office, for example, at about 08:00. At this time, the first customer goes from home to AA Station and gets on a train at AA Station. Thereafter, the first customer gets off the train at BB Station and heads for the company from BB Station.

For example, the first customer works at the company between about 08:00 and about 17:00.

The first customer leaves the office at, for example, about 17:00 and returns home at, for example, about 18:00. At this time, the first customer goes from the company to BB Station and gets on a train at BB Station. Thereafter, the first customer gets off the train at AA Station and goes home from AA Station.

In the first database 41, a daily schedule SCA1 of each day in a certain period is registered for each customer.

Note that the schedule SCA1 as shown in FIG. 2 is registered in the first database 41 by the customer operating his/her own information terminals 10.

### Second Database

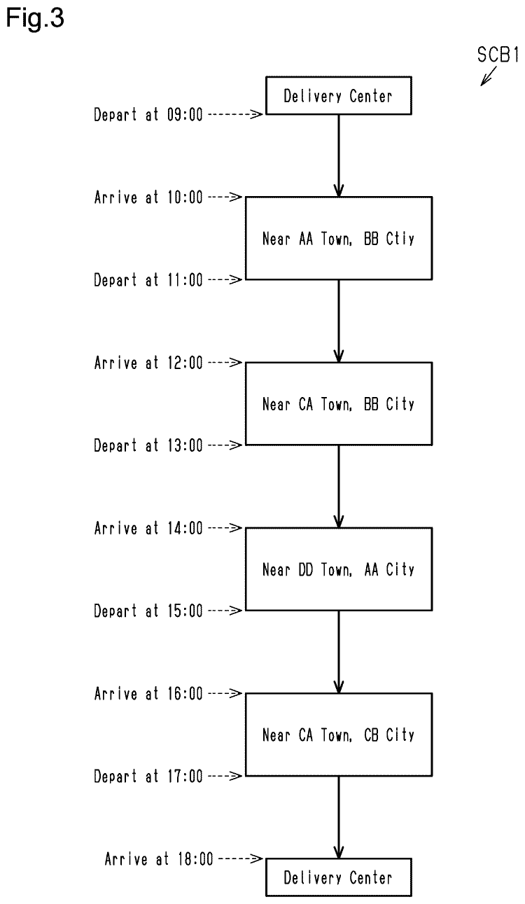

The information registered in the second database 42 will be described with reference to FIG. 3. In the second database 42, delivery schedules SCB of parcels in multiple delivery vehicles are registered.

FIG. 3 illustrates a delivery schedule SCB1 of a certain day of a first delivery vehicle among multiple delivery vehicles. In the example shown in FIG. 3, the delivery schedule SCB1 is as follows.

The first delivery vehicle departs from the delivery center at about 09:00, for example, and arrives at near AA Town, BB City at about 10:00, for example.

The first delivery vehicle departs from near AA town, BB city at about 11:00, for example, and arrives at near CA town, BB city at about 12:00, for example.

The first delivery vehicle departs, for example, from a location near CA town, BB city at about 13:00 and arrives, for example, at a location near DD town, AA city at about 14:00.

The first delivery vehicle departs, for example, from near DD Town, AA City at around 15:00 and arrives, for example, at near CA Town, CB City at around 16:00.

The first delivery vehicle departs from a location near CA town, CB city at, for example, about 17:00 and returns to the delivery center at, for example, about 18:00.

In the second database 42, the delivery schedule SCB1 of each day in a certain period is registered for each delivery vehicle.

### Third Database

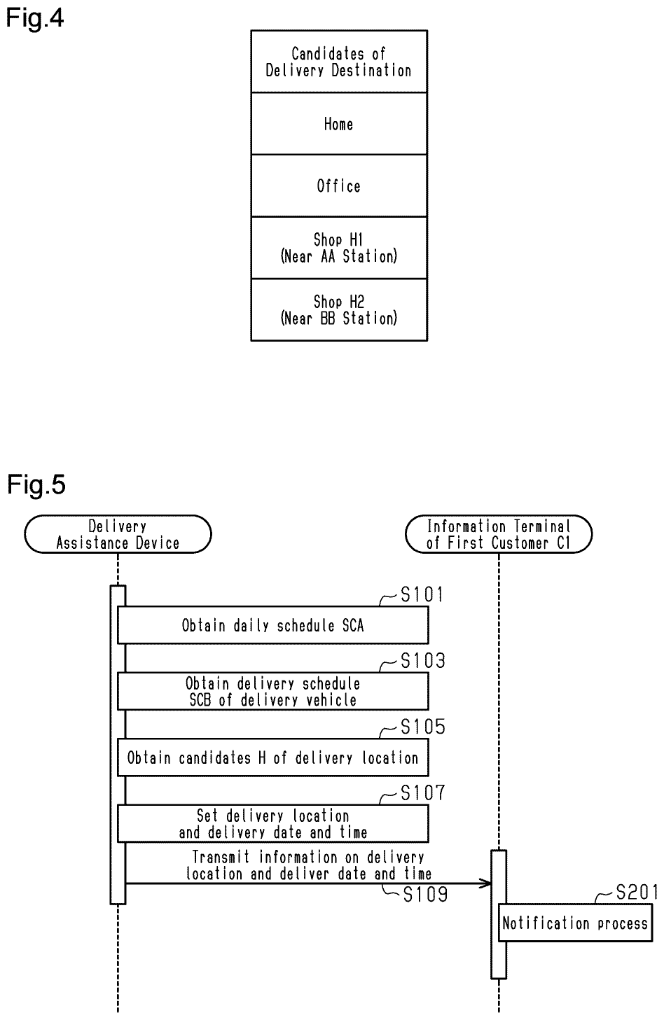

The information registered in the third database 43 will be described with reference to FIG. 4. In the third database 43, a candidate H of a location where a parcel is delivered to a customer is registered for each customer.

FIG. 4 illustrates an example of a candidate H of a location where a parcel is delivered to the first customer. In the example shown in FIG. 4, the home of the first customer, the company at which the first customer works, the store H1, and the store H2 are registered as the candidates H. The shop Hl is a shop near AA Station. The store H2 is a store near BB station.

Flow of Processes when Proposing Delivery Location and Delivery Date and Time to Customer.

With reference to FIG. 5, a flow of processing for proposing a delivery location and a delivery date and time to a customer will be described. Here, a case in which the delivery location and the delivery date and time are proposed to the first customer C1 will be described as an example.

In step S101, the controller 32 of the delivery assistance device 30 obtains the daily schedule SCA of the first customer C1 from the first database 41. At this time, the controller 32 obtains the daily schedules SCA of all days registered in the first database 41 by the first customer C1.

In the subsequent step S103, the controller 32 obtains the delivery schedule SCB of the delivery vehicle from the second database 42. At this time, the controller 32 obtains the delivery schedule SCB for multiple days.

In the next step S105, the controller 32 obtains multiple candidates H registered in the third database 43.

Then, in step S107, the controller 32 sets the delivery location and the delivery date and time on the basis of the obtained schedule SCA1, the delivery schedule SCB, and the candidates H. Details of the process of setting the delivery location and the delivery date and time will be described later.

In the next step S109, the communication device 31 of the delivery assistance device 30 transmits information regarding the delivery location and the delivery date and time set by the controller 32 in step S107 to the information terminal 10 of the first customer C1.

When the information terminal 10 receives the information, the processing circuitry 15 of the information terminal 10 executes the process of step S201. In step S201, the processing circuitry 15 executes notification processing of notifying the first customer C1 of the delivery location and the delivery date and time included in the information received from the delivery assistance device 30. For example, in the notification process, the processing circuitry 15 displays the delivery location and the delivery date and time on the display screen of the user interface 11.

### Process of Setting Delivery Location and Delivery Date and Time

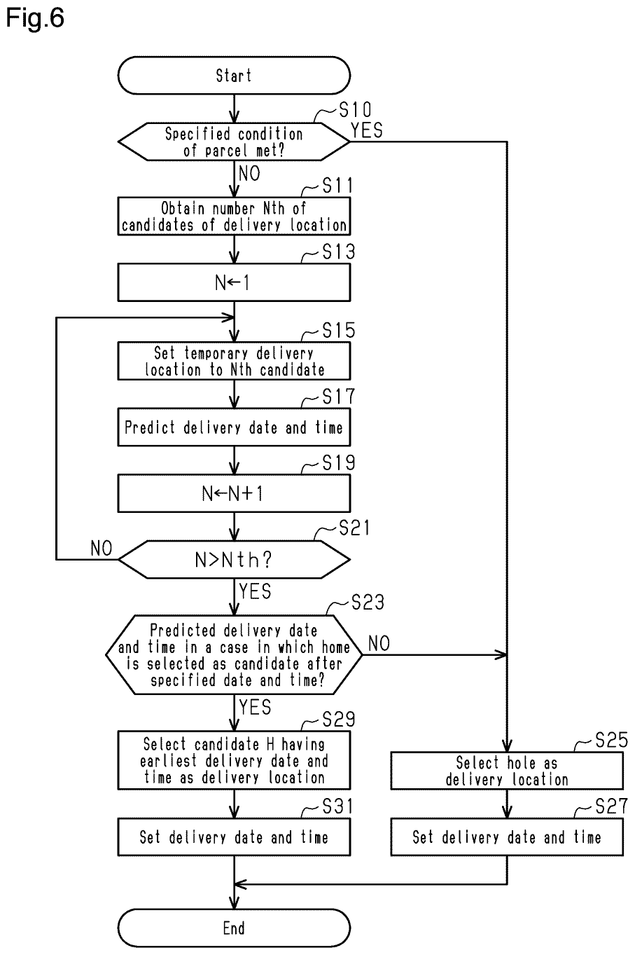

An example of a process of setting a delivery location and a delivery date and time executed by the controller 32 of the delivery assistance device 30 will be described with reference to FIG. 6. Hereinafter, the process of setting the delivery location and the delivery date and time is simply referred to as a setting process.

In step S10, the controller 32 determines whether or not a specified condition of the parcel is satisfied. The specified condition of the parcel is a condition of a parcel for which the home is preferably set as the delivery location. For example, the controller 32 determines whether or not the specified condition of the parcel is satisfied based on the size and the weight of the parcel. In this case, the controller 32 may determine that the specified condition of the parcel is satisfied when at least one of the following two conditions (A1) and (A2) is satisfied. On the other hand, the controller 32 may determine that the specified condition is not satisfied when none of the two conditions (A1) and (A2) is satisfied.

(A1) The size of the parcel is equal to or larger than a size determination value.

(A2) The weight of the parcel is equal to or greater than a weight determination value.

When the customer receives the parcel at a location other than his/her home, such as a company, the customer comes home with the parcel. At this time, if the parcel is relatively large or the parcel is relatively heavy, it is difficult for the customer to return home with the parcel. Therefore, the size of the parcel that can be determined to be too large for carrying the parcel is set as the size determination value. In addition, a weight that can be determined to be too heavy to carry the parcel is set as the weight determination value.

When the controller 32 determines that the specified condition of the parcel is satisfied (S10: YES), the controller 32 shifts the processing to step S25. On the other hand, when the controller 32 determines that the specified condition of the parcel is not satisfied (S10: NO), the controller 32 shifts the processing to step S11.

In step S11, the controller 32 obtains the number Nth of delivery location candidates. In the example shown in FIG. 4, the number Nth of candidates is 4. In the next step S13, the controller 32 sets the coefficient N to 1. Then, the controller 32 shifts the process to step S15.

In step S15, the controller 32 sets an Nth candidate H (N) among the Nth candidates H as a temporary delivery location.

In the subsequent step S17, the controller 32 predicts a delivery date and time at which the parcel can be delivered to the first customer C1 at the temporary delivery location. Here, the predicted delivery date and time is referred to as a predicted delivery date and time. For example, the controller 32 extracts a first date and time which is a date and time at which the first customer C1 can proceed to the temporary delivery location based on the daily schedule SCA of the first customer C1. The controller 32 extracts a second date and time which is a date and time at which the first delivery vehicle can proceed to the temporary delivery location based on the delivery schedule SCB. The controller 32 searches for a date and time at which both of the first customer Cl and the first delivery vehicle can go to the temporary delivery location based on the first date and time and the second date and time. Then, the controller 32 sets the date and time closest to the current date and time among the searched dates and times as the predicted delivery date and time.

In the next step S19, the controller 32 updates the coefficient N so that the coefficient N is increased by one. In step S21, the controller 32 determines whether or not the updated coefficient N is larger than the number Nth of candidates. When the coefficient N is larger than the number Nth of candidates (S21: YES), the controller 32 shifts the processing to step S23. On the other hand, when the coefficient N is equal to or less than the number Nth of candidates (S21: NO), the controller 32 shifts the processing to step S15. That is, the controller 32 repeatedly executes the processing from step S15 to step S21 until the setting of the predicted delivery date and time for all the candidates H is completed.

In step S23, the controller 32 determines whether or not the predicted delivery date and time when the home is set as the temporary delivery location is after the specified date and time. The specified date and time is a date and time when a specified number of days have elapsed from the current date and time. The specified number of days is a number of days that can be set by the customer. Therefore, it can be said that the specified date and time is a date and time set by the customer.

In a case in which the controller 32 determines that the predicted delivery date and time in a case in which the home is set as the temporary delivery location is after the specified date and time (S23: YES), the controller 32 shifts the process to step S29. On the other hand, when the controller 32 determines that the predicted delivery date and time in a case in which the home is set as the temporary delivery location is not after the specified date and time (S23: NO), the controller 32 causes the process to proceed to step S25.

In step S25, the controller 32 selects the home as the delivery location. In the next step S27, the controller 32 sets the predicted delivery date and time in a case in which the home is set as the delivery location as the delivery date and time. Thereafter, the controller 32 ends the setting process.

In step S29, the controller 32 selects the candidate H having the earliest delivery date and time among the candidates H as the delivery location. In this case, the controller may select a place other than the home as the delivery place. In the next step S31, the controller 32 sets the predicted delivery date and time of the delivery location selected in step S29 as the delivery date and time. Thereafter, the controller 32 ends the setting process.

### Operation and Advantages of Present Embodiment

(1) The controller 32 of the delivery assistance device 30 sets a delivery location and a delivery date and time based on the daily schedules SCA of the customers and the delivery schedule SCB of the delivery vehicle. That is, the delivery location and the delivery date and time are set in consideration of the convenience of both the customer and the delivery vehicle. When the delivery vehicle goes to the delivery location at such a delivery date and time, the delivery person using the delivery vehicle can deliver the parcel to the customer at the delivery location. Accordingly, the delivery assistance device 30 reduces the possibility of redelivery of the parcel.
(2) In the third database 43, the multiple candidates H, including the home, are registered as locations where the parcel can be delivered to the customer. The controller 32 selects one of the candidates H as the delivery location in consideration of convenience of both the customer and the delivery vehicle.

A case will now be considered in which the delivery assistance device does not include the third database 43. In this case, the controller of the delivery assistance device needs to search for a candidate for the delivery location based on the delivery plan of the delivery vehicle and the action plan of the customer. That is, the processing load of the controller increases when the controller sets the delivery location.

In this regard, the delivery assistance device 30 includes the third database 43. The controller 32 thus does not need to search for multiple candidates. This allows the delivery assistance device 30 to set the delivery location and the delivery date and time while suppressing an increase in the processing load on the controller 32.
(3) When determining that the parcel can be delivered to the customer within a specified number of days if the parcel is delivered to the customer's home, the delivery assistance device 30 sets the delivery location to the home. On the other hand, when determining that the parcel cannot be delivered to the customer within the specified number of days if the parcel is delivered to the customer's home, the delivery assistance device 30 sets the deliver location to a location other than the home. That is, when determining that the delivery of the parcel cannot be completed by the date and time desired by the customer if the delivery location is set to the home, the controller 32 sets the delivery location to a candidate at which the delivery of the parcel can be completed the earliest among the candidates H. This allows the delivery assistance device 30 to prevent the number of days required for delivery of the parcel to the customer from becoming excessively long.
(4) When the parcel is delivered to the customer at a location other than the home, the customer carries the parcel home. At this time, if the parcel is large or heavy, it significantly increases the burden on the customer when returning home. In this regard, the controller 32 of the delivery assistance device 30 sets the delivery location to the home when determining the parcel is too large or too heavy. The delivery assistance device 30 thus prevents the customer's burden from becoming excessive when returning home.

### Modifications

The above-described embodiments described above may be modified as follows. The above-described embodiment and the following modifications can be combined as long as the combined modifications remain technically consistent with each other.

The controller 32 may determine that the specified condition of the parcel illustrated in FIG. 6 is satisfied when the parcel is a parcel that needs to be refrigerated or a parcel that needs to be frozen.

In the setting process shown in FIG. 6, the determination in step S10 may be omitted.

The specified date and time may not be changed by the customer.

It is not essential for the delivery assistance device to comprise a third database 43.

The controller 32 is not limited to a device that includes a CPU and a ROM and executes software processing. That is, the controller 32 may be modified to have any one of the following configurations (a) to (c).
(a) The controller 32 includes one or more processors that execute various processes in accordance with a computer program. Each processor includes a CPU and a memory, such as a RAM and a ROM. The memory stores program codes or instructions configured to cause the CPU to execute processes. The memory, which is a computer-readable medium, includes any type of media that are accessible by general-purpose computers and dedicated computers.
(b) The controller 32 includes one or more dedicated hardware circuits that execute various processes. The dedicated hardware circuits include, for example, an application specific integrated circuit (ASIC) and a field programmable gate array (FPGA).
(c) The controller 32 includes a processor that executes part of various processes according to programs and a dedicated hardware circuit that executes the remaining processes.

It should be noted that the expression “at least one” as used herein means “one or more” of the desired options. As an example, the expression “at least one” as used herein means “only one option” or “both two options” if the number of options is two. As another example, the expression “at least one” used herein means “only one option” or “a combination of any two or more options” if the number of options is three or more.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. A delivery assistance device configured to assist delivery of parcels to customers who receive a parcel delivery service using a delivery vehicle, the delivery assistance device comprising:
a first database in which daily schedules of the customers are registered;
a second database in which a delivery schedule of the parcels in the delivery vehicle is registered; and
a controller that includes processing circuitry, wherein the processing circuitry is configured to
set a delivery location and a delivery date and time at which the delivery vehicle delivers each parcel to the corresponding customer based on the daily schedules of the customers and the delivery schedule of the parcels in the delivery vehicle, and
propose the delivery location and the delivery date and time to the corresponding customer.

2. The delivery assistance device according to claim 1, further comprising a third database in which candidates of locations where the parcels are delivered to the customers are registered for each customer, wherein
the processing circuitry is configured to, in a case of setting the delivery location and the delivery date and time,
select one candidate from the candidates as the delivery location based on the daily schedules of the customers and the delivery schedule of the parcels in the delivery vehicle, and set the delivery date and time to a date and time at which the delivery
vehicle can proceed to the delivery location.

3. The delivery assistance device according to claim 1, wherein the processing circuitry is configured such that, in a case of setting the delivery location and the delivery date and time,
if the delivery date and time for a case in which the delivery location is assumed to be set to the home of the customer is earlier than a specified date and time that is after the current date and time, the processing circuitry sets the delivery location to the home of the customer, and sets the delivery date and time to a date and time at which the delivery vehicle can proceed to the delivery location, and
if the delivery date and time for a case in which the delivery location is assumed to be set to the home of the customer is after the specified date and time, the processing circuitry sets the delivery location to a location other than the home of the customer, and sets the delivery date and time to a date and time at which the delivery vehicle can proceed to the delivery location.

4. The delivery assistance device according to claim 3, wherein the specified date and time is a date and time set by the customer.

5. The delivery assistance device according to claim 1, wherein the processing circuitry is configured to, in a case of setting the delivery location and the delivery date and time, set the delivery location and the delivery date and time based on the daily schedules of the customers, the delivery schedule of the parcels in the delivery vehicle, and the size and the weight of each parcel.
